(19) United States
(12) Patent Application Publication
(10) Pub. No.: US 2023/0206265 A1
(43) Pub. Date: Jun. 29, 2023

(54) OPTIMIZED DYNAMIC PRICING ENGINE

(71) Applicant: WAY INC., Fremont, CA (US)

(72) Inventors: Binumon Thamarashn GIRIJA, Sunnyvale, CA (US); Nagappan ARUNACHALAM, Palo Alto, CA (US); Rangarakesh KANCHAMREDDY, Hyderabad (IN); Lakshmi Sowjanya KALARI, Milpitas, CA (US)

(73) Assignee: WAY INC., Fremont, CA (US)

(21) Appl. No.: 18/089,269

(22) Filed: Dec. 27, 2022

Related U.S. Application Data
(60) Provisional application No. 63/293,877, filed on Dec. 27, 2021.

(51) Int. Cl. G06Q 30/0201; G06Q 20/40

(52) U.S. Cl. CPC G06Q 30/0206; G06Q 20/4016

(57) ABSTRACT

Embodiments presented herein disclose a dynamic pricing engine for optimized dynamic pricing of a product by considering price elasticity of the user. Specific modules of the engine are configured to: receive a user input corresponding to an online product and collect behavioral data of a user based on the user input; access an updated user profile corresponding to the user based on the collected behavioral data and a fraud score associated with the user; determine a relevance score, for all displayed products, based at least on the received user profile; determine a baseline price of the product, for the user, based on one or more of the relevance score associated with the user profile and various external and internal attributes; and determine a personalized price of the product for the user, based on the baseline price and a price differential that is computed by considering the user's price elasticity.

### CROSS REFERENCE TO RELATED APPLICATION

This application claims the benefit of U.S. Provisional Patent Application Ser. No. 63/293,877, titled “OPTIMIZED DYNAMIC PRICING ENGINE”, filed on Dec. 27, 2021, which is assigned to the assignee hereof and hereby, expressly incorporated by reference herein.

### FIELD OF THE INVENTION

The embodiments discussed in the present disclosure are generally related to dynamic pricing of products in an electronic commerce (e-commerce) environment. In particular, the embodiments discussed are related to providing an optimized dynamic pricing engine that is responsive to price elasticity of customers in an e-commerce environment.

### BACKGROUND OF THE INVENTION

An e-commerce portal connects buyers and sellers to conduct transactions related to various products. Conventional e-commerce portals use dynamic pricing algorithms to adapt to variations in supply, demand, pricing and/or other factors such as seller attributes, customer interest and location, etc. A challenge associated with the conventional pricing algorithms is that they may not have price of a product and/or service optimized for a specific customer. Therefore, there is a need to overcome this challenge by providing a more dynamic pricing mechanism.

### OBJECT OF THE INVENTION

An object of the embodiments presented herein is to provide an optimized dynamic pricing engine to optimize a price of a product that may be displayed on an e-commerce portal, by personalizing the price of the product according to a price elasticity (i.e., price sensitivity) of a specific user. Another objective of the embodiments presented herein may be to provide an optimized dynamic pricing engine that is configured to compute baseline prices of products that are relevant for a user's profile segment.

Another objective of the embodiments presented herein may be to create personalized offers for various users, by adding a price differential, unique to each user, to a baseline price of a product.

Yet another objective of the embodiments presented herein is to determine a highest price at which a user (e.g., a customer of a bookable product) may buy a product from a seller (e.g. a vendor of the bookable product). For example, this aspect may be equivalent to selling an antique item at $10 a unit to customer 1 and at $20 a unit to customer 2 while creating a perception for both users that they got a desirable deal. This may prompt the customers to return to the seller for subsequent purchases. The embodiments presented herein facilitate using the inherent dynamic nature of prices of bookable products to sell them at different prices to different customers based on the approach outlined later in this disclosure.

Another objective of the embodiments presented herein may be to present such offers in online marketing campaigns to the user.

Another objective of the embodiments presented herein, may be to orchestrate the presentation of prices of products in a manner that the content, prices, discounts, taxes and fees are displayed to the users. This may assist the seller to sell displayed items at the highest price that customer is willing to pay within a price range. For example, a user may set a budget range of $5.00 to $7.50 for buying an item on a seller's e-commerce portal. Therefore, the seller would want to sell the item at $7.50 to the user. The embodiments presented herein may also use psychological biases of users in a manner to display prices of all sold out items in the range of $5.00 to $7.00 and all remaining prices in the range of $7.50 to $10.00 so that the user would feel delighted that they are able to get an item within their budget.

The other objectives and advantages of the present disclosure will be apparent from the following description when read in conjunction with the accompanying drawings, which are incorporated for illustration of preferred embodiments of the present disclosure and are not intended to limit the scope thereof.

### SUMMARY OF THE INVENTION

Embodiments of an optimized dynamic pricing engine and a corresponding method are disclosed that address at least some of the above challenges and issues.

Embodiments presented herein disclose a method implemented on a dynamic pricing engine for optimized dynamic pricing. The method includes receiving a user input corresponding to an online product and collecting behavioral data of a corresponding user based on the user input. The method further includes accessing an updated user profile corresponding to the user based on the collected behavioral data and a fraud score associated with the user. The method further includes determining a relevance score, for all items/products that are presented to the user, based at least on the accessed user profile. The method further includes determining a baseline price of the product based on one or more of the relevance score associated with the user profile and one or more attributes, and subsequently, determining a personalized price of the product based on the baseline price and a price differential.

Embodiments presented herein disclose a dynamic pricing engine for optimized dynamic pricing. The engine includes a processor and a memory configured to store computer-executable instructions that when executed, configure the processor to receive a user input corresponding to an online product and collect behavioral data of a user based on the user input. The instructions further configure the processor to access an updated user profile corresponding to the user based on the collected behavioral data and a fraud score associated with the user and determine a relevance score, for all items/products that are presented to the user, based at least on the accessed user profile. The instructions further configure the processor to determine a baseline price of the product based on one or more of the relevance score associated with the user profile and one or more attributes and subsequently, determine a personalized price of the product based on the baseline price and a price differential.

Embodiments presented herein disclose a non-transitory computer readable medium comprising computer-executable instructions, which when executed, configure a processor to perform the steps comprising receiving a user input corresponding to an online product, collecting behavioral data of a corresponding user based on the user input, accessing an updated user profile corresponding to the user based on the collected behavioral data and a fraud score associated with the user, determining a relevance score, for all items/products that are presented to the user, based at least on the accessed user profile, determining a baseline price of the product based on one or more of the relevance score associated with the user profile and one or more attributes, and subsequently, determining a personalized price of the product based on the baseline price and a price differential.

### BRIEF DESCRIPTION OF THE DRAWINGS

Further advantages of the invention will become apparent by reference to the detailed description of preferred embodiments when considered in conjunction with the drawings:

FIG. 1 illustrates an optimized dynamic pricing engine and its associated internal modules, according to an embodiment.

FIG. 2 is a flowchart to illustrate a method for an optimized dynamic pricing of products, according to an embodiment.

FIG. 3 illustrates a processor and various internal modules included in the optimized dynamic pricing engine, according to an embodiment.

FIG. 4A illustrates an exemplary pricing listing scenario, according to an embodiment.

FIG. 4B illustrates an exemplary e-commerce portal, according to an embodiment.

### DETAILED DESCRIPTION

The following detailed description is presented to enable any person skilled in the art to make and use the invention. For purposes of explanation, specific details are set forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to one skilled in the art, and the general principles defined herein may be applied to other embodiments and applications without departing from the scope of the invention. The present invention is not intended to be limited to the embodiments shown but is to be accorded the widest possible scope consistent with the principles and features disclosed herein.

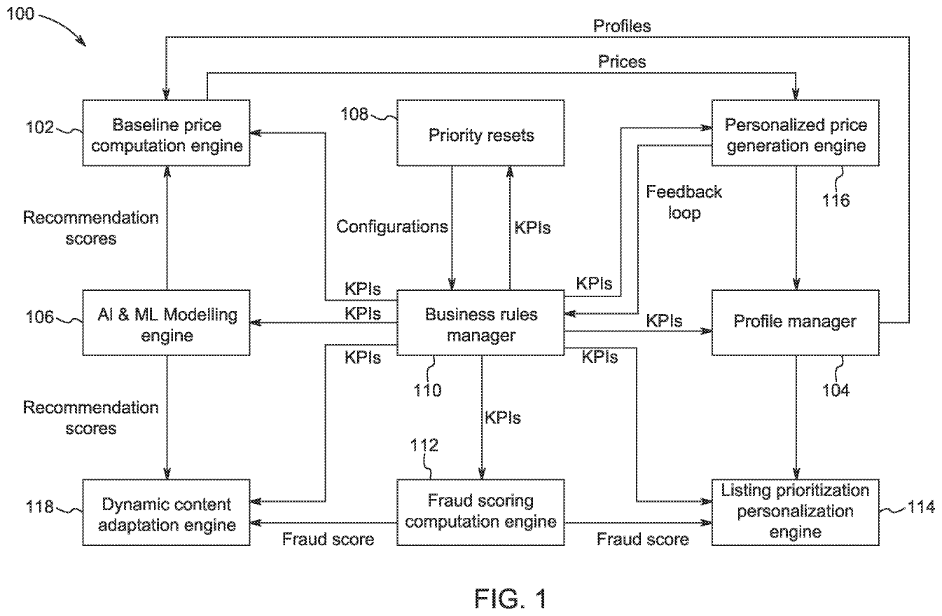

The embodiments of the methods and systems are described in more detail with reference to FIGS. 1-4.

FIG. 1 illustrates an optimized dynamic pricing engine 100, in accordance with an embodiment. The engine 100 may include various modules to implement the embodiments presented herein. In an embodiment, the optimized dynamic pricing engine 100 may include modules such as, but not limited to, a baseline price computation engine 102, a profile manager module 104, an Artificial Intelligence and Machine Leaning (AI & ML) modelling engine 106, a priority resets module 108, a business rules manager 110, a fraud scoring computation engine 112, a listing prioritization and personalization engine 114, a personalized price generation engine 116, a dynamic content adaptation engine 118. A person skilled in the art would understand that any combination of these modules may be implemented as hardware and/or software modules depending on implementation requirements.

The functions of the above-mentioned modules are, without limitation, are described below:

Baseline price computation engine 102: The baseline price computation engine 102 may determine baseline prices of products. In an embodiment, a baseline price may be a price that may be similar for different users have similar user profiles on a specific time instance. However, a baseline price for a product for a specific time instance may be different from the price for the same product on a different time instance.

In an embodiment, the baseline price computation engine 102 may compute a baseline price of a product that the user may be interested in, based on various inputs received from other modules of the optimized dynamic pricing engine 100 or from external sources. In one example, the baseline price computation engine 102 may receive inputs from external sources that include market data (including competitor details such as prices, reviews, industry data), user-related details (e.g. user profiles) from profile manager module 104, predicted demand and supply values for the product from the AI & ML modelling engine 106, configuration settings values (e.g. target profit margin, target utilization, etc.) from the priority resets module 108, pricing rules and profit computation rules from the business rules manager 110, fraud probability values from the fraud scoring computation engine 112, and relevance scores and priority values for one or more products from the listing prioritization and personalization engine 114. Further, the baseline price computation engine 102 may accordingly determine the baseline price of the product based on one or more of these inputs. The baseline price computation engine 102 may perform similar functions for computation of baseline prices for multiple products that the user(s) may be interested in purchasing.

In an embodiment, the baseline price computation engine 102 may set the prices of products in such a manner that they are in alignment with the profit targets subject to underlying business conditions, supply contracts, and partnership terms. In one example, the baseline price computation engine 102 may consider internal revenue targets, a supplier's revenue expectation, profit margins to determine the baseline price for a specific product. The baseline price computation engine 102 may continuously monitor internal and external sources to respond to variations in these factors in near real time by continuously updating the baseline price of the product.

In an exemplary scenario, when a user is interested in buying a parking space for a specific day (e.g. an upcoming Sunday), the baseline price computation engine 102 (e.g., of an optimized dynamic pricing engine associated with a parking vendor) may check prices for its competitor vendors to set the parking vendor's baseline price within x % of the competitors' prices. A numerical value for x % may be set based on the vendor's target profit margins. In an additional embodiment, the baseline price computation engine 102 may further check a utilization rate (i.e., number of parking spaces available/total number of parking spaces) and add a premium to the zero percent utilization price. For example, prices of a parking lot may be relatively higher, if 60% spaces at that parking lot are already sold for selected time slots versus prices set when 40% utilization rate is reached. In yet an additional embodiment, the baseline price computation engine 102 may also check predicted demand for that parking lot in next 1 hour and check the current hour sales trend to set price in such a way that the sales are in line with the expected demand. The above-described rules may set a same baseline price for all users of the same user profile for the selected time slot.

After the baseline price computation engine 102 applies the above-mentioned rules, the baseline price computation engine 102 may apply additional rules that are specific to a user profile. E.g. a user profile may be determined based on one or more of, but not limited to, a device used by the user (e.g., iPhone 14), a user's physical address (e.g., rental accommodation), per capita income, a cellular network (e.g. 4G), and a vehicle owned/used by the user, etc. This information may be used to remove any affordability discount so that the baseline prices are not lower than the vendor's competitor's prices. Here, the profile manager module 104 may be configured to determine and store user profiles. The profile manager module 104 may additionally be configured to provide the user profiles to baseline price computation engine 102 for implementing the above-described rules on the user profiles. This example illustrates how baseline price computation engine sets prices for one of the services that can be sold through e-commerce website. Other factors such as, but limited to, weather, seasonal factors, etc. may also be considered if they are appropriate for the design requirements.

Profile manager module 104: The profile manager module 104 may classify users that interact with the e-commerce portal, into different user profiles and store these profiles in a memory associated with the profile manager module 104. In one example, the profile manager module 104 may use modeling algorithms to classify users into various user profiles so that different users are grouped together to predict behavior for users with similar characteristics. This classification may later enable the optimized dynamic pricing engine 100 to analyze their browsing behavior and interaction with the e-commerce portal and accordingly, personalize prices of products based on such user profiles.

In an embodiment, the profile manager module 104 may additionally receive inputs from other modules of the optimized dynamic pricing engine 100 to continually update user profiles. In one example, the profile manager module 104 may receive one or more business rules from the business rules manager 110, configuration settings from the priority resets module 108, fraud prediction values from fraud score computation engine 112, and past purchase data and behavior data for a specific user from external sources to create and store various user profiles.

In an exemplary scenario, if a user is driving an electric vehicle (e.g., Tesla Model S), the profile manager module 104 may classify the user as either a profile named ‘EV charging vehicle’ or ‘personal sedan users’ based on business rules that specify that a vehicle used/owned by the user is a criteria used for pricing. For instance, if prices for parking for EV vehicles are set to lower values to incentivize users to use chargers set up at parking lots, the profile manager module 104 may create a new profile within a profile called ‘personal sedan cars’, as ‘personal use EV sedan cars’. If prices for parking EVs are same as other vehicles of similar dimensions (length, width, height), the profile manager module 104 may not create the profile ‘personal use EV sedan cars’.

In another example, if an average price of a luxury vehicle segment is changed from $120K to $100K, the profile manager 104 may update the profiles of Tesla model S drivers to categorize them into a different user profile. In yet another example, if the fraud score computation engine 112 determines users who had cancelled a parking lot booking twice in the previous month as potentially fraudulent users to be offered a benefit, all users who meet that criteria may be moved into a new profile, by the profile manager 104. In this embodiment, the benefit may not be credited to the user in case of cancellations but may be credited to users of the other profile when the original order is cancelled so that they can reuse that benefit with future orders.

Thus, the profile manager 104 may keep updating profiles constantly based on changes in the economy, industry and behavioral patterns, once these inputs are sent by various aforementioned modules to the profile manager 104.

In an embodiment, an output from profile manager module 104 may be a user's profile category and competitor's profile category that may be used by the optimized dynamic pricing engine 100 to efficiently predict price elasticity of different categories of users.

In an embodiment, the profile manager module 104 may also classify competitor portals into different profile categories to analyze competitor pricing and adapt the pricing displayed on e-commerce portal accordingly. In one example, the profile manager module 104 may provide competitor profile categories to the AI & ML modelling engine 106 to predict competitor behavior for different products to predict their response. This may enable an internal team associated with the e-commerce portal to monitor and adapt the pricing of a specific product. Alternately, the optimized dynamic pricing engine 100 may automatically adapt the pricing of the product within predefined limits previously set by the internal team. In one example, a pricing aggressive competitor is expected to respond to a price drop to match the reduced price. This information may be used to reduce prices in an incremental manner to ensure that the prices displayed on the e-commerce portal may be competitive for the user.

AI & ML Modelling Engine 106: The AI & ML Modelling Engine 106 predicts a supply and demand for all bookable products (e.g. a parking lot) along with the relevance values for such bookable products, using known AI & ML algorithms. In one example, the bookable products may include products for which inventory may be available with a seller/vendor and the user may be interested in purchasing it (e.g. the products being browsed by the user). In an embodiment, this engine may receive inputs from external sources about market data (including competitor details such as prices, reviews, and industry data), user profile details from the profile manager module 104, baseline prices from the baseline price computation engine 102, configuration settings values from the priority resets module 108, pricing rules and profit computation rules from the business rules manager 110, fraud probability values from fraud scoring computations engine 112, and relevance and priority values along with the bookable products from listing prioritization and personalization engine 114. Based on these received values, the AI & ML modelling engine 106 may determine supply and demand predictions that may be provided to one or more other modules of the optimized dynamic pricing engine 100 as inputs, as described in the context of the respective modules.

In one example, the AI & ML Modelling Engine 106 may implement one or more known modeling algorithms to predict supply and demand values. The AI & ML Modelling Engine 106 may additionally implement self-learning algorithms to improve these modelling algorithms based in real-time.

In an exemplary scenario, if a trend projected by the AI & ML Modelling Engine 106 expects returning users visiting the seller's website through email campaigns with promotional codes, the profile manager module 104 may classify these users as ‘highly price sensitive’. The business rules manager 110 may mandate that the prices for the products need to be kept higher than the average prices. The AI & ML Modelling engine 106 may accordingly revise the demand downwards and determine a higher pricing range for the products. The AI & ML modelling engine 106 may provide the pricing range that is appropriate for meeting business objectives so that the baseline price computation engine 102 may use this information to assign baseline prices accordingly. The AI & ML modelling engine 106 may also revise the pricing range based on historical trends.

In an embodiment, the Listing prioritization and personalization engine 114 may provide a latest content associated with different user profiles so that the AI & ML modeling engine 106 may predict the impact of the content on the demand of a bookable product. For example, users who visit buildings or destinations nearby a parking lot may prefer to park at that garage. In this example, the presented content may not have listed any nearby restaurants. If the content does not list any restaurant as nearby locations and users who land on the page are considered as gourmets, AI & ML modeling engine would revise the demand because those users may not prefer this parking lot.

In another example, if the business rules manager 110 specifies that the profit margins of the seller should be higher for the luxury car segment, the AI & ML modelling engine 106 may provide a list of options that are appropriate for this new target to cover the supply shortfall. It is observed that the luxury car owners prefer to park at the parking lots that provide 24×7 surveillance and security and may not prefer to park in the garages that do not offer the same benefits. The embodiments of this invention may consider these observations and inputs to determine the baseline price of the product.

Priority Resets module 108: The priority resets module 108 may include one or more configurable parameters that may impact the outcome of remaining modules of the optimized dynamic pricing engine 100. In one example, an internal team associated with the e-commerce portal of the seller, may provide inputs related to these configurable parameters via an administrative panel to control an overall output (e.g. final price of the product) of the optimized dynamic pricing engine 100. In one example, the priority resets module 108 may determine based on the received inputs, one or more configuration settings values such as target profit margin and/or target utilization, and then, provide them to the business rules manager 110. The business rules manager 110 may further provide these values in the form of key performance indicators (KPIs) to the baseline price computation engine 102 to compute baseline prices in accordance with the KPIs. The priority resets module 108 may thus, ensure that the outcome of the optimized dynamic pricing engine 100 is based on the KPIs.

In the above embodiment, KPIs are the parameters that have target values in alignment with overall business objectives associated with the e-commerce portal. In one example, one KPI may be that a targeted gross market value (GMV) for a set of product categories associated with the e-commerce portal should be $5 million for an ongoing month. A second KPI parameter may be that a targeted Net Revenue associated with the e-commerce portal may be $10 million for an ongoing financial year. A third KPI parameter may be that a targeted month-on-month (MoM) revenue growth may be 5% for a business vertical.

In another example, the priority resets module 108 may determine a threshold value for a fraud probability score such that any user whose score is more than the threshold value may not be allowed to buy products from the e-commerce portal. In one example, the threshold value may be provided by the internal team. The priority resets module 108 may also be configurable to adjust the frequency at which it may receive input from external sources, either automatically or via manual inputs provided by the internal team. In an embodiment, the fraud scoring computation engine 112 may compute the fraud scores (or values) and the priority resets module 108 may determine whether users who have a specific fraud score, are allowed to buy certain products or not.

Business rules manager 110: The business rules manager 110 may receive various business rules from business admins that are required to determine the final price of the product in accordance with business objectives associated with the e-commerce portal. The business rules may be received as inputs from an internal team associated with the e-commerce portal through the administrative panel. In one example, the business rules may include rules associated with an operating environment of the e-commerce portal. For instance, the business rules may include rules such as, but not limited to, pricing rules, supply contracts, revenue share agreements and so on. The business rules manager 110 may determine one or more KPIs based on these business rules and provide the KPIs to other modules of the optimized dynamic pricing engine 100, as illustrated in FIG. 1, to ensure that their outputs are implemented according to the business rules.

In one example, a profit margin target for different markets for different time periods is stored as a business rule. Therefore, all other modules of the optimized dynamic pricing engine 100 receive this business rule from the business rules manager 110 to ensure that their respective outputs are computed according to the business rules. For instance, if a business rule specifies that the target profit margin for a current month is 20%, other modules of the pricing engine may be aligned to this rule. For instance, the listing prioritization and personalization engine 114 may give a higher weightage to products with higher margins in computation of relevance ranking. Consequently, the listing prioritization and personalization engine 114 may set relevance rankings of products in a manner that the margin of products that are likely to be purchased by the user(s) is 20%.

Fraud scoring computation engine 112: The fraud scoring computation engine 112 may compute a fraud score corresponding to each user, who may be a potential buyer on the e-commerce portal. In one example, fraud scoring computation engine 112 may use modeling algorithms to compute the fraud score associated with each user based on inputs from profile manager module 104, configuration settings from priority resets module 108, business rules from the business rules manager 110, and historical data from external sources. In one example, if the priority resets module 108 has set chargebacks (cancellation rate) for a current month as less than 1%, the fraud scoring computation engine 112 may not allow users who share relatively lower percentage of similarities with known fraudulent users. In one example, if 5% of users who have purchased travel related products 30 days before their travel date are identified as fraudulent users, the fraud scoring computation engine 112 may mark a user who selected dates that are 30 days before travel date as fraudulent users to achieve the 1% chargeback configuration setting.

Listing Prioritization and Personalization Engine 114: The listing prioritization and personalization engine 114 may generate a relevance score for all bookable products that the user may be interested in, based on user's behavior data and preferences along with other inputs. The other inputs may include or more or more of, but not limited to, duration associated with the user's trip, fuel prices, weather conditions, distance between the source and destination of the trip, a price segment of the user's device, and so on. In one example, this engine may receive historical browsing or purchase data from external sources (e.g., flight schedules, flight delays, weather updates, interest rates, gas prices etc.), user profile details from the profile manager module 104, predefined business rules from the business rules manager 110, and predefined configuration settings from the priority resets module 108. The listing prioritization and personalization engine 114 may accordingly generate a personalized relevance score for each bookable product and an associated user. The personalized relevance score, along with other inputs discussed earlier in this disclosure, may then be used to determine the baseline price of a product.

In an exemplary scenario, if a user is considered extremely price sensitive and additionally prefers security related features, all products that are competitively priced along with the security features would be allocated higher relevance scores for the user. For instance, if a user is interested in a parking spot for parking near Los Angeles International Airport, the prices may be kept below $10 per day along with security and surveillance to ensure that the user's favorite car is protected. Once the user visits the parking vendor's website or e-commerce portal, a parking lot with the lowest price along with security and surveillance features would be assigned the highest relevance score and the one with a relatively higher price along with the expected features would have higher relevance score but lower than the previous parking lot that is more suitable for the user.

In one example, for instance, if a user is found to be interested in renting covered self-parking lots, the relevance score for that user may be determined based on one or more criteria such as, but not limited to, a past purchase date, their profile, availability of parking lots on a selected date(s), a determination regarding whether the user has parked their vehicle in a specific parking lot in the past, a determination regarding whether the user has submitted a review/rating of the specific parking lot in the past, a comparison between features of multiple parking lots, an improvement in review/rating of a specific parking lot compared to a previous review/rating submitted by the user, competitor pricing of similar parking lots, and a general preference of other users towards a specific parking lot that the user is interested in renting.

The listing prioritization and personalization engine 114 may determine a quantitative value for each of the above criteria and may determine the relevance score based on the summation of values of all the criteria to determine the relevance score for each parking lot displayed to the user. The outcome of the listing prioritization and personalization engine 114 along with the business rules determines the products that would be displayed to the user and the display position of each of such products.

Personalized Price Generation Engine 116: The personalized price generation engine 116 may receive baseline prices of one or more products from the baseline price computation engine 102. In an embodiment, this engine may compute a price differential with respect to a baseline price of a product. All modules including the baseline pricing computation engine may provide their output to the personalized price generation engine 116. For instance, the listing prioritization and personalization engine 114 may provide the list of items and their display rank to the personalized price generation engine 116 so that the latter considers only those items that would get displayed to the user.

The personalized price generation engine 116 may update personalized discounts/premiums for the products in such a manner that the prices are positioned to achieve the profit margin targets. For instance, if the profit margin target is 15%, a baseline price differential for a price sensitive user may be −$0.5. The differential for the same user in same conditions would be set as −$0.4 in order to achieve a 20% profit margin.

In an example, any combination of the following price differentials may be computed by this engine:

Price differential based on past purchases: This personalized price generation engine 116 may compute this differential based on a price paid by a user in a past purchase of the product. In one example, this engine may additionally compare the computed differential with the prices paid by other customers for the same product during the same time-period. In one example, for a product, the personalized price generation engine 116 may evaluate a differential in the price paid by other customers in user's price category and compare this differential with the price paid by the user in the past purchase. This comparison would be used to adjust a price differential set for the users associated with user's current profile category and make necessary adjustments based on the past data to ensure that the probability of purchase for this item is optimized. In an exemplary scenario, a user A may have purchased an item when the price differential was +$0.05 whereas an average price differential paid by all users in user A's profile segment is +$0.03 for the same item. It is possible that the price differential for this user may be set at 1 cent or 2 cents higher than the price differential set for this user's profile. In this embodiment, the price differential value may be different for users that belong to a same profile segment based on their past purchases.

Price differential based on price rankings of the purchased products: This differential may be computed based on price ranking of the purchased products at the time of purchase. In one example, the price ranking may be computed based on the base line prices set for all products that are available for purchase for one or more options selected by user. (e.g. product category, price range, and so on). The lowest priced product in a product category may be assigned rank 1 and the rank may increase as per the price of all products in the group. Price ranking-based differential may then be computed as follows. The price differential may be computed based on the rationale that the price of the top ranked product may not be more than the price of the top ranked (by price) product in a similar category on a competitor's portal. Specifically, the price of other top ranked products may be less than a similarly ranked product on the competitor portal by a predetermined amount, which may be considered as the price differential. This algorithm may also be implemented for a group of top-ranked products (e.g. ranks 1-5 by price).

Price differential based on past purchase behavior: This differential may be computed based on user behavior associated with past purchases and price elasticity of the user that may be determined based on the user behavior. In one example, if a user has clicked on specific monetary modules of ‘taxes and duties’ associated with the product, the engine may deduce that the user may be sensitive to price of the product. In another example, a user clicking on a ‘sort by price’ option may indicate that the user is sensitive to price. The price differential may accordingly be computed based on this deduction. A person skilled in the art would understand that this price differential may be different than a price differential that would be determined on the basis of past purchases.

Price differential based on device profile: This differential may be computed based on user's device and a pricing rank of the device among several devices. In one example, if a user is using a premium smartphone, the personalized price generation engine 116 may compute a differential based on the price ranking of the smartphone among several smartphones. In one example, this engine may determine devices used by a user during a predefined time period in the past (for example, past 3 years) and present interactions and accordingly, compute the price differential. A device used in an ongoing interaction with the e-commerce portal may be given a higher weightage compared to a device used in a previous interaction, while computing this price differential.

In an exemplary scenario, a user may have used a popular mobile device such as, but not limited to, Vivo Y39S (price rank 50) 3 years ago, Xiaomi Redmi Note 9 Pro (price rank 40), or iPhone 13 Pro Max (Price rank 5). When the user visits the web site on which bookable products are listed, the dynamic pricing engine 100 may set a price differential of this user lower than another user who had used iPhone 11 (price rank 3) and iPhone 12 (price rank 2) 2 years ago and iPhone 13 Pro Max (Price rank 5), for the current visit to the website.

Price differential based on user's location: This differential may be computed based on location of a user while interacting with the e-commerce platform. In one example, if a user is located in a premium locality or zip code and accessing the e-commerce platform at night with a device with a higher price ranking, this engine may determine that user is less sensitive to the prices and accordingly, compute this price differential. The price differential for such a user may be higher compared to a user who may be sensitive to price of the product.

Price differential based on the current interactions: This differential may be computed based on product details that a user may be interested in, and interactions associated with a current session while browsing a product. In one example, if a user interacts with non-pricing details in the current interactions compared to price details, this information may be considered by the engine while computing a price differential. For example, the price differential for a user who had clicked on an option to expand taxes and feed may be lower than the price differential for another user who had only browsed features of the product, if all other details are same between both users.

Price differential based on the user pricing profile: As per user's past interactions and current profile and interaction data, each user is associated with a pricing profile. E.g. a user who completes the purchase only by applying the promo code from an ‘abandoned cart’ email sent by the e-commerce platform, may be associated with one pricing profile while another user who frequently makes a purchase during their first visit to a product landing page may be associated with another pricing profile.

Price differential based on other services usage: This differential may be computed based on usage of any other services consumed by a user. In one example, pricing rank for the other services and/or products purchased by the user may be used to compute price differential. For instance, if the user buys expensive car wash product which has a high price ranking, pricing differential corresponding to that purchase may be computed accordingly.

Price differential Aggregate: This differential may include an overall price differential based on above-described individual differentials and weightages associated with each differential. In one example, a price differential aggregate may be computed based on the price differential based on user pricing profile and a price differential based on other services usage. Here, the price differential computed based on user pricing profile may have a higher weightage than the pricing differential value based on the other services usage.

In an embodiment, the price differential aggregate may be a weighted average of the relevance of all price differentials that are mentioned above. In an exemplary scenario, Price differential aggregate for user A=2*Price differential based on past purchases+1.5*Price differential based on price rankings of the purchased products+1.2*Price differential based on past purchase behavior+0.8*Price differential based on device profile+0.7*Price differential based on user's location+1.5*Price differential based on the current interactions+1.2*Price differential based on the user pricing profile+1.3*Price differential based on other services' usage.

However, the co-efficient for each price differential is dynamic and likely to be different for different users and also different for same user for different items. A person skilled in the art would understand that the above illustrated co-efficients are only illustrated as examples and do not limit the presented embodiments in any manner.

In one example, the personalized price generation engine 116 may additionally consider the following:
Average price paid by the user for all past purchases
Discounts received on the past purchases
Average number of user sessions for each past purchase by the user (e.g., if user has completed all purchases in a single session or multiple sessions)
Price ranking of the purchase items among all other bookable items
Average taxes and fees among past purchases.

Further, the personalized price generation engine 116 may set a value to ensure that a pricing rank of the previously booked product falls within a pricing rank of the past purchased items. The personalized price generation engine 116 may then set a value to ensure that the price is discounted by an amount same as the discounts in past purchases with respect to the baseline price for the visit count (e.g., for a user who visits the e-commerce portal multiple times to complete purchase of a product). The personalized price generation engine 116 may then set a price to ensure that the price is in a desired range of average price of products.

In an embodiment, the pricing differential computed above may be sub-divided into a baseline price differential and taxes/fees price differential. This may be because the price of the product, that the user pays may include includes taxes and fees. Further, different users may react differently to the subtotal (price excluding taxes and fees), taxes and fees, and timing/purchase funnel stage for the presentation of this information. In one example, the price differential may be considered only in the form of a ‘taxes and fees’ differential based on the product category and user profile such that users who are more concerned about comparison of subtotal across different websites would not see a higher price. For instance, the e-commerce portal may display a baseline price differential for a relatively lesser price-sensitive user compared, considering that the user is interested in the product compared to the price of the product.

In an embodiment, the AI & ML Modelling Engine 106 may additionally include a feedback loop (not shown) to make real-time adjustments to the computed price differential. In one example, a feedback from the AI & ML Modelling Engine 106 may be provided to the marketing team so that they can use business rules manager 110 to modify one or more business rules based on the feedback and business rules manager sends updated rules to the impacted components so that they make necessary adjustments in alignment with the new rules. This may further enable the personalized price generation engine 116 to determine more personalized values for the computed price differential in accordance with current conversion rates and other priorities and/or business rules specific to the user. Therefore, this engine makes the dynamic pricing value truly personalized to match the price of a product with the price that user is willing to pay.

Dynamic content adaptation engine 118: Dynamic content adaptation engine 118 may optimize by personalizing or adapting any content displayed on the e-commerce portal in a dynamic manner such that the content displayed for each product may be personalized to provide the details that are relevant for a specific user.

In one example, users who drive oversized vehicles may be interested to know any additional parking charges associated with their vehicles. In one example, the dynamic content adaptation engine 118 may personalize the parking charges in a manner that additional parking charges may be highlighted and displayed to such users on their devices. However, this information may not be displayed to the users who do not drive oversized vehicles.

In another example, the dynamic content adaptation engine 118 may also include details such as full address of a destination if the user is a traveler but display only street name if the user is a resident staying in proximity to the destination. In yet another example, such information may be emailed to the user on receiving a user input.

In yet another example, if a user is driving an expensive car, security related features and details may be highlighted for that user. Similarly, if a user who prefers to get their car washed on the way back to home from a shopping trip, the dynamic content adaptation engine 118 may display the nearby shopping destinations. If a user who prefers to get car washed at a car wash station to take advantage of the discounts offered to gas station customers, the dynamic content adaptation engine 118 may adapt the content displayed by the e-commerce portal to display all wash stations from a specific operator.

As described in the above examples, the dynamic content adaptation engine 118 may adapt the details associated with the products that the user is interested in purchasing, and accordingly display them to the user.

In an embodiment, the dynamic content adaptation engine 118 may include a badge to prompt the user to prefer the items that have higher profit margins. For instance, the dynamic content adaptation engine 118 may include a badge labelled as ‘trending’ to such products to increase the probability of such products being purchased.

In an embodiment, the dynamic content adaptation engine 118 may receive user's profile from profile manager module 104, a relevance score for a product listing from the listing prioritization and personalization engine 114, and configuration settings from priority resets module 108 to personalize the price of the product, specific to the user based on these values.

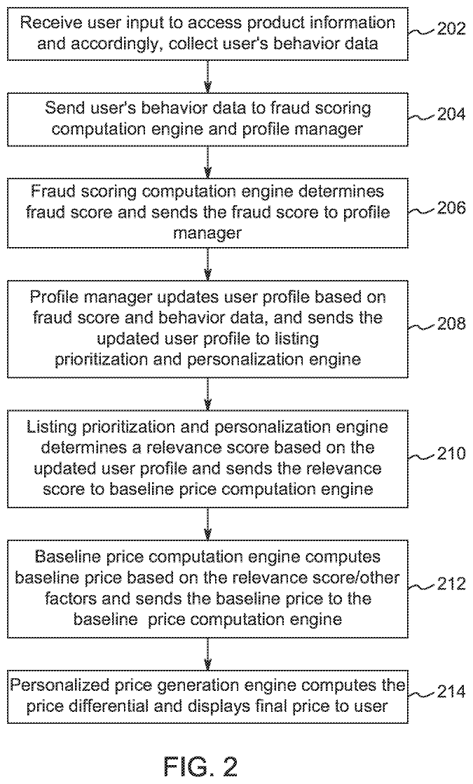

FIG. 2 is a flowchart to illustrate a method for dynamic pricing of products, according to an embodiment. A processor associated with the optimized dynamic pricing engine (e.g. dynamic pricing engine 100) may execute some or all the steps illustrated in this figure. In an embodiment, the processor may invoke various modules, as described in the context of FIG. 1 to execute different steps illustrated in FIG. 2 and described in more detail below. Additionally, the modules of the optimized dynamic pricing engine described in the context of FIG. 2 may perform functions equivalent to their corresponding modules described in the context of FIG. 1.

In an embodiment, in step 202, the processor may receive a user input to access product information on an e-commerce portal. In one example, the processor may determine that a user (potential buyer of the product) may be browsing the e-commerce portal to access product specifications, pricing, reviews and/or any other information associated with the product on a product landing page on the e-commerce portal. In step 202, the processor may accordingly collect user's behavior data based on their interaction with the e-commerce portal. In an embodiment, the processor may be included in or in communication with an analytics engine (not shown), which is configured to collect the behavior data, process the data and provide the data to various modules of the dynamic pricing engine 100, as illustrated in FIG. 1. The behavior data may include various data and/or insights into the browsing behavior of the user. For instance, the behavior data may indicate the sections of a product landing webpage that the user interacts with, the frequency of visiting the product landing webpage, number of clicks on a price-specific section on the product landing webpage, and/or categories of products purchased in the past, and so on. In an embodiment, the behavioral data indicates a browsing behavior of the user and further wherein, the behavioral data comprises an indication of one or more of sections of a product landing webpage that the user has browsed, a frequency of visiting the product landing webpage, a number of clicks on a price-specific section on the product landing webpage, and categories of products purchased by the user in the past.

In step 204, the processor may send the user's collected behavior data to the fraud scoring computation engine 112 and the profile manager module 104.

In step 206, the fraud scoring computation engine 112 may determine a fraud score associated with the user and send the fraud score to profile manager module 104. In one example, the fraud scoring computation engine 112 may receive one or more user profiles from the profile manager module 104 and determine the fraud score for corresponding users associated with each of the received user profiles based on the behavior data of the corresponding users and one or more additional factors as described in the context of FIG. 1. In another example, the fraud score computation engine 112 may also consider predefined configuration settings received from the priority resets module, predefined business rules received from the business rules manager 110 and/or historical data on user's browsing behavior to determine the fraud score based on these inputs. Once the fraud score is computed, the fraud score computation engine 112 sends the fraud score for the corresponding user(s) to the profile manager module 104.

In step 208, the profile manager module 104 may update the user profile based on the received fraud score and the user's behavior data. In an embodiment, the user profile may already be stored in a memory associated with the profile manager module 104 and may be continuously updated based on repeated interactions of the user with the e-commerce portal to browse or purchase products. In another embodiment, if the profile is not already stored, the profile manager module 104 may create the user profile during the user's first interaction with the e-commerce portal and may subsequently update the user profile. Once the user profile is updated, the profile manager module 104 may send the updated user profile to the listing prioritization and personalization engine 114.

In step 210, the listing prioritization and personalization engine 114 may determine a relevance score based on the updated user profile that it receives from the profile manager module 104. The relevance score may be determined for all the items/products listed on the seller's online portal that the user may be browsing for a potential purchase.

Once the listing prioritization and personalization engine 114 accesses the user profile, it may send the relevance score to the baseline price computation engine 102, for determining the baseline price of a product based on the relevance score. In an embodiment, the relevance score may be determined based on additional inputs as well, as described in the context of FIG. 1. In an embodiment, the listing prioritization and personalization engine 114 may determine relevance scores for all products that the user may be interested in purchasing. Such products may, for instance, be determined as likely to be purchased, by analyzing the user's behavior data while browsing the products.

In step 212, the baseline price computation engine 102 may compute a baseline price based for the product on the relevance score and additional factors described in the context of FIG. 1. For instance, the baseline price of the product may be determined additionally based on various external and internal attributes such as, but not limited to, competitor prices, weather updates, projected utilization rates and other factors discussed in the context of FIG. 1. These external and internal attributes may impact the supply and demand of the product that the user may potentially purchase and is currently browsing.

In an embodiment, the AI & ML modelling engine 106 may receive descriptive information related to all bookable products from the dynamic content adaptation engine 118 and may subsequently, send supply and demand projections for all such products for different user categories to the baseline price computation engine 102. For example, the user profile categories may be, but not limited to, ‘price sensitive’, ‘oversized vehicle’, ‘high mileage’, ‘cross country traveler’, ‘convenience focused luxury car owner’, ‘security obsessed’, ‘EV sedan’, ‘metro local traveler’.

The baseline price computation engine 102 may accordingly compute the baseline price based on these projections as additional factors. Once the baseline price is computed, the baseline price computation engine 102 may send the baseline price to the personalized price generation engine 116.

In step 214, the personalized price generation engine 116 may compute a price differential as described in the context of FIG. 1. Further, the personalized price generation engine 116 may add this price differential to the baseline price to compute a price of the product that may be later, displayed to the user on the product landing page of the e-commerce portal. Embodiments of the present invention, thus, enable a price elasticity of the user to be considered in the computation of the final price of the product. Therefore, the final price displayed to the user may be a personalized price corresponding specifically to the user when the user visits the e-commerce portal. In one example, this personalized price may be presented to the user in an online marketing campaign (e.g., via emails or targeted advertisements) even before the user visits the e-commerce portal. In an embodiment, this personalized price is adjustable based on a behavioral data of at least another user who browsed the online product and one or more behavioral differences between the behavioral data of the user and the behavioral data of the other user. For instance, the personalized price may also be dependent on the behavior of the other user who may have responded to the prices and details presented to them so that the necessary adjustments are made in prices to convert the subject user as well by accounting for other user(s)' behavioral differences to the profile's behavioral characteristics. In an optional embodiment, the optimized pricing engine 100 may also display some other products as sold out or unavailable for purchase to the user to prompt the user to buy a specific product.

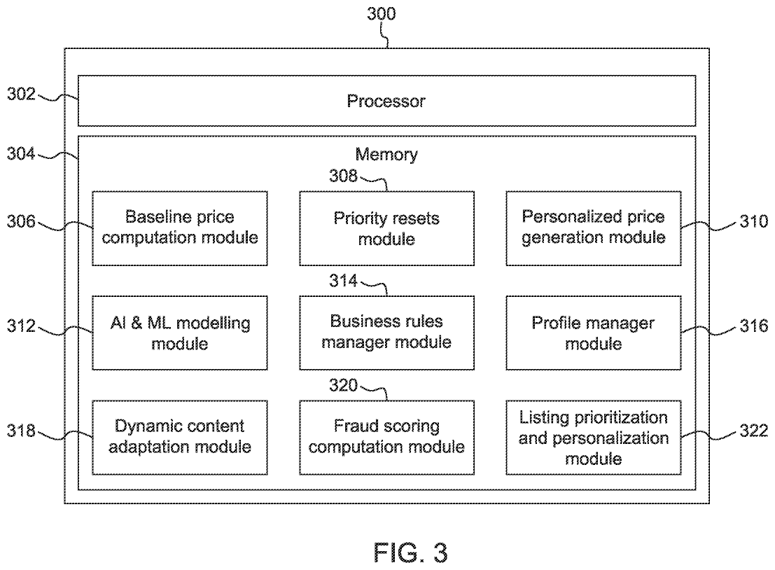

FIG. 3 illustrates a dynamic pricing engine 300 that may include a processor 302 and a memory 304, which may include various modules.

The processor 302 may be a physical or virtual processing component that may be located either locally or remotely with respect to the dynamic pricing engine 300. In one example, the processor 302 may be virtually deployed as a remote server and may communicate with other modules of the dynamic pricing engine 300 via a communication network by using any known communication interfaces. Further, the processor 302 may be implemented using one or more processing technologies known in the art. Examples of the processor 302 may include, but are not limited to, an x86 processor, a RISC processor, an ASIC processor, a CISC processor, or any other processor known in the art.

Further, the memory 304 may include, but not limited to, a baseline price computation module 306, a priority resets module 308, a personalized price generation module 310, an AI & ML modelling module 312, a business rules manager module 314, a profile manager module 316, a dynamic content adaptation module 318, a fraud scoring computation module 320, a listing prioritization and personalization module 322, and other modules. In an embodiment, the baseline price computation module 306 may perform similar functions as the baseline price computation engine 102. The priority resets module 308 may perform similar functions as the priority resets module 108. The personalized price generation module 310 may perform similar functions as the personalized price generation engine 116. The AI & ML modelling module 312 may perform similar functions as the AI & ML modelling engine 106. The business rules manager module 314 may perform similar functions as the business rules manager 110. The profile manager module 316 may perform similar functions as the profile manager module 104. The dynamic content adaptation module 318 may perform similar functions as the dynamic content adaptation engine 118. The fraud scoring computation module 320 may perform similar functions as the fraud scoring computation engine 112. The listing prioritization and personalization module 322 may perform similar functions as the listing prioritization and personalization engine 114. These modules may, without limitation, implement equivalent functions as their corresponding modules described in the context of FIGS. 1 and 2 and are not described again for brevity. Further, the processor 302 may include suitable logic, circuitry, and/or interfaces that are operable to execute one or more computer-executable instructions stored in the above-mentioned modules in the memory 304 to perform the steps described in the context of FIG. 2. The memory 304 may be operable to store one or more instructions.

Further, the optimized dynamic pricing engine 300 may be physically or virtually deployed as a cloud application, in a server that may host the e-commerce portal. In another embodiment, any subset of the above-described modules may be hosted on any number or type of servers at same or different geographical locations without any limitation with respect to their respective functions. The optimized dynamic pricing engine 300 may also be remotely accessible to a user associated with the e-commerce portal for configuration of one or more functions of the optimized dynamic pricing engine 100 based on the implementation requirements.

Although FIG. 3 illustrates the above-mentioned modules as separate modules, a skilled person would appreciate that these modules may or may not be included as separate modules in memory 304 in the form of computer-executable instructions that may be executed to enable the processor to perform the steps illustrated in FIG. 2. Any subset of these modules may be implemented as a single module or separate modules and any subset of these modules may be implemented as dedicated hardware modules instead of being included as memory-based software modules.

In an embodiment, the memory 304 may utilize one or more non-transitory computer-readable storage media for implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include random access memory (RAM), read-only memory (ROM), volatile memory, nonvolatile memory, hard drives, CD-ROMs, DVDs, flash drives, disks, and any other known physical storage media.

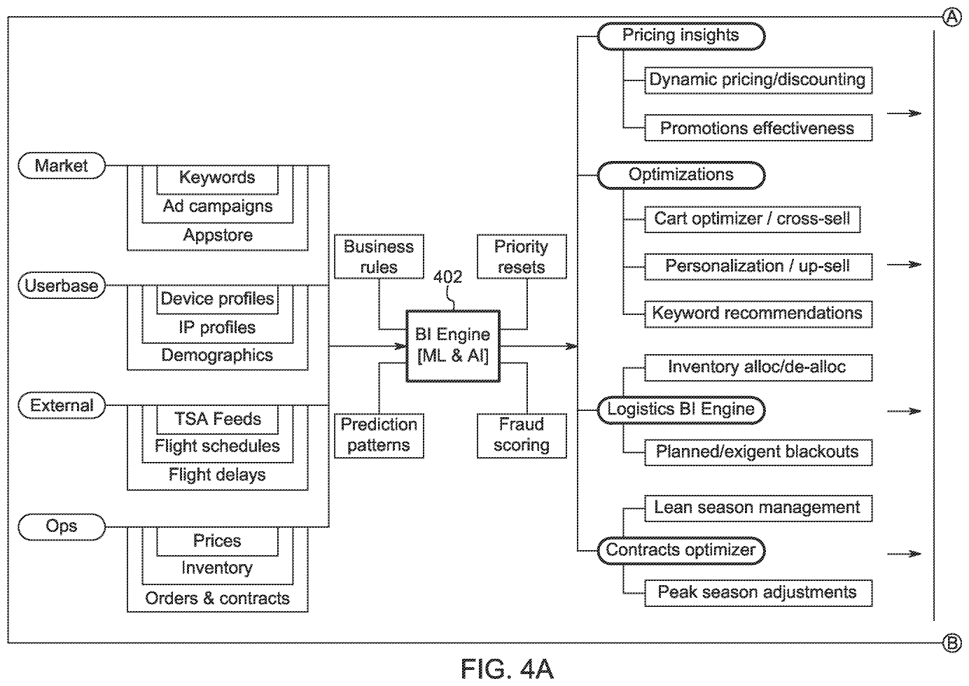

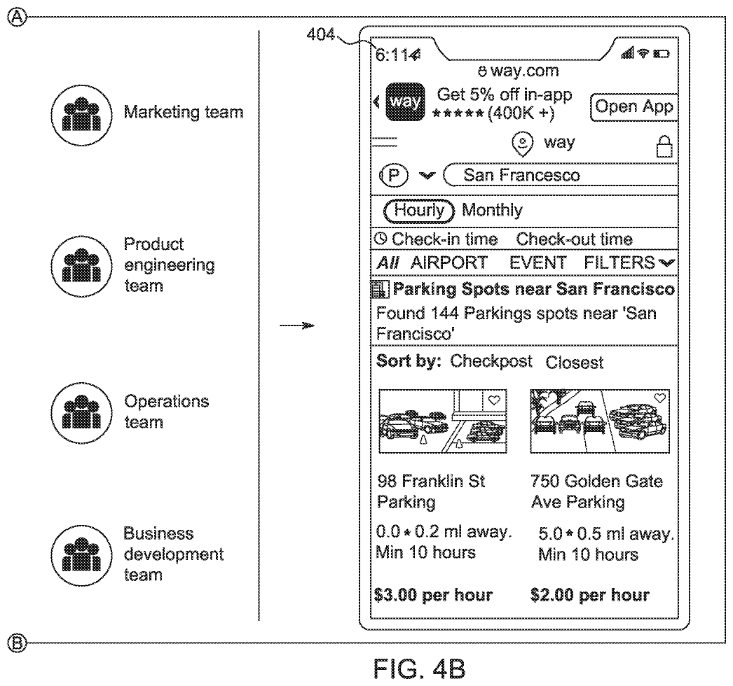

FIG. 4A illustrates an exemplary pricing listing scenario implemented by the dynamic pricing engine 100 associated with the e-commerce portal, according to an embodiment. In this exemplary scenario a business intelligence (BI) engine 402 may perform similar functions as the AI & ML modelling engine 106, in accordance with the embodiments presented herein. BI engine 402 may receive one or more inputs from various illustrated external sources and accordingly, determine supply and demand predictions for each product to be displayed to the user. In an embodiment, BI engine 402 may provide its output (e.g. demand and supply predictions) to one or more teams associated with the e-commerce portal 404, to adapt AI & ML modules used by the BI engine 402 to any additional business criteria that such teams may define. This may enable the BI engine 402 to provide a more accurate output to the personalized price generation engine 116. In an embodiment, the final price may be displayed by the e-commerce portal 404 against each product listed on e-commerce portal 404, as illustrated in FIG. 4B.

In accordance with the embodiments presented herein, the e-commerce portal may be displayed via a user interface on a device associated with the user, as a software application, website, a web application, or in any known content rendering form for displaying online content. Further, the device may include, but not limited to, a smartphone, a tablet, a laptop, a smartwatch, a desktop computer, an augmented reality headset, a smart television (TV) or any other known display device that may have computing capabilities to receive inputs from the BI engine 402 and display the user interface associated with the e-commerce portal 404.

The terms “comprising,” “including,” and “having,” as used in the claim and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition, or step being referred to is an optional (not required) feature of the invention.

The invention has been described with reference to various specific and preferred embodiments and techniques. However, it should be understood that many variations and modifications may be made while remaining within the spirit and scope of the invention. It will be apparent to one of ordinary skill in the art that methods, devices, device elements, materials, procedures, and techniques other than those specifically described herein can be applied to the practice of the invention as broadly disclosed herein without resorting to undue experimentation. All art-known functional equivalents of methods, devices, device elements, materials, procedures, and techniques described herein are intended to be encompassed by this invention. Whenever a range is disclosed, all subranges and individual values are intended to be encompassed. This invention is not to be limited by the embodiments disclosed, including any shown in the drawings or exemplified in the specification, which are given by way of example and not of limitation. Additionally, it should be understood that the various embodiments of the networks, devices, and/or modules described herein contain optional features that can be individually or together applied to any other embodiment shown or contemplated here to be mixed and matched with the features of such networks, devices, and/or modules.

While the invention has been described with respect to a limited number of embodiments, those skilled in the art, having benefit of this disclosure, will appreciate that other embodiments can be devised which do not depart from the scope of the invention as disclosed herein.

I/We claim:

1. A method implemented on a dynamic pricing engine for optimized dynamic pricing, the method comprising:
receiving a user input corresponding to an online product;
collecting behavioral data of a corresponding user based on the user input;
accessing an updated user profile corresponding to the user based on the collected behavioral data and a fraud score associated with the user;
determining a relevance score based at least on the accessed user profile;
determining a baseline price of the product for the user based on one or more of the relevance score associated with the user profile and one or more attributes; and
determining a personalized price of the product for the user based on the baseline price and a price differential.

2. The method of claim 1, wherein the user input comprises an input to access information associated with the online product on an e-commerce portal.

3. The method of claim 1, wherein the collected behavioral data indicates a browsing behavior of the user and further wherein, the behavioral data comprises an indication of one or more of sections of a product landing webpage that the user has browsed, a frequency of visiting the product landing webpage, a number of clicks on a price-specific section on the product landing webpage, and categories of products purchased by the user in the past.

4. The method of claim 1, further comprising determining the fraud score corresponding to the user based on one or more of the behavioral data, one or more predefined configuration settings, and one or more predefined business rules.

5. The method of claim 1, further comprising updating a stored user profile corresponding to the user based on the collected behavior data and the fraud score to create the updated user profile.

6. The method of claim 1, wherein the determined personalized price is adjustable based on a behavioral data of at least another user who browsed the online product and one or more behavioral differences between the behavioral data of the user and the behavioral data of the another user.

7. The method of claim 1, wherein the relevance score is determined based on one or more of historical browsing or purchase data, the user profile, one or more predefined business rules, and one or more predefined configuration settings and further wherein, the attributes comprise one or more of competitor prices, weather updates, and projected utilization rates that impact supply and demand of the product.

8. The method of claim 1, wherein the baseline price is determined additionally based on predetermined supply and demand projections of the product.

9. The method of claim 1, wherein determining the final price comprises an addition of the price differential to the baseline price.

10. The method of claim 1, wherein the price differential is based on user-specific parameters comprising one or more of a past purchase behavior of the user, a price ranking of one or more past purchases made by the user, a stored pricing profile of the user price sensitivity of the user, usage of one or more other products and/or services by the user, a device profile of the user, a location of the user, and an interaction pattern of the user during an ongoing browsing session corresponding to the product.

11. The method of claim 1, further wherein the price differential is divided into a baseline price differential component associated with the product, and a taxes and fees component associated with the product.

12. The method of claim 11, further comprising presenting one or more of the baseline price differential component, and the taxes and fees component to the user based on a price sensitivity of the user.

13. The method of claim 1, further comprising displaying one or more other products as sold out or unavailable for purchase to the user.

14. A dynamic pricing engine for optimized dynamic pricing, the engine comprising:
a processor; and
a memory configured to store computer-executable instructions that when executed, configure the processor to:
receive a user input corresponding to an online product;
collect behavioral data of a user based on the user input;
access an updated user profile corresponding to the user based on the collected behavioral data and a fraud score associated with the user;
determine a relevance score based at least on the accessed user profile;
determine a baseline price of the product based on one or more of the relevance score associated with the user profile and one or more attributes; and
determine a personalized price of the product based on the baseline price and the price differential.

15. The engine of claim 14, wherein the user input comprises an input to access information associated with the online product on an e-commerce portal.

16. The engine of claim 14, wherein the collected behavioral data indicates a browsing behavior of the user and further wherein, the behavioral data comprises an indication of one or more of sections of a product landing webpage that the user has browsed, a frequency of visiting the product landing webpage, a number of clicks on a price-specific section on the product landing webpage, and categories of products purchased by the user in the past.

17. The engine of claim 14, wherein the processor is further configured to update a stored user profile corresponding to the user based on the collected behavior data and the fraud score to create the updated user profile.

18. The engine of claim 14, wherein the processor is further configured to determine the relevance score based on one or more of historical browsing or purchase data, the user profile, one or more predefined business rules, and one or more predefined configuration settings and further wherein, the attributes comprise one or more of competitor prices, weather updates, and projected utilization rates that impact supply and demand of the product.

19. The engine of claim 13, wherein the price differential is based on user-specific parameters comprising one or more of a past purchase behavior of the user, a price ranking of one or more past purchases made by the user, a stored pricing profile of the user price sensitivity of the user, usage of one or more other products and/or services, a device profile of the user, a location of the user, and an interaction pattern of the user during an ongoing browsing session corresponding to the product.

20. A non-transitory computer readable medium comprising computer-executable instructions, which when executed, configure a processor to perform the steps comprising:
collecting behavioral data of a user based on the user input;
accessing an updated user profile corresponding to the user based on the collected behavioral data and a fraud score associated with the user;
determining a relevance score based at least on the accessed user profile;
determining a baseline price of the product based on one or more of the relevance score associated with the user profile and one or more attributes; and
determining a personalized price of the product based on the baseline price and a price differential.
